(19) United States
(12) Patent Application Publication
(10) Pub. No.: US 2010/0218383 A1
(43) Pub. Date: Sep. 2, 2010

(54) Levered blade actuator

(76) Inventor: James Lee Williams, Texas City, TX (US)

Correspondence Address: ROYSTON RAYZOR VICKERY & WILLIAMS L.L.P., 306 - 22ND STREET, SUITE 301, GALVESTON, TX, 77550, US

(21) Appl. No.: 12/290,712

(22) Filed: Nov. 3, 2008

Related U.S. Application Data
(60) Provisional application No. 61/001,365, filed on Nov. 1, 2007.

(51) Int. Cl. B26B 1/02

(52) U.S. Cl. 30/158

(57) ABSTRACT

A levered actuator in a knife controls movement of the blade between open and closed positions. The knife includes a blade having a tang pivotally fixed to a liner of the knife handle. The blade is operatively coupled to a levered actuator by a blade pin which rides in a groove formed in the liner and an actuator groove formed in the actuator. A digit tab extends away from the back of the knife handle for operation of the actuator. The pivoting actuator moves the blade by moving the blade pin.

### CROSS REFERENCE

This patent application claims priority to U.S. Provisional Patent Application No. 61/001,365 filed Nov. 1, 2007 entitled Levered Blade Actuator and U.S. Provisional Patent Application No. 61/130,272 filed May 29, 2008 entitled Levered Blade Actuator.

### BACKGROUND

1. Technical Field

Generally, this invention relates to cutlery, multitool or any folding implement that folds or otherwise retracts into the handle to protect the implement, such as a blade, for example, while not in use. Specifically, this invention relates to implements in which a means is provided for positively moving the blade from the handle and locking the blade in either an open or closed position.

2. Description of the Related Art

In the cutlery industry, a folding knife includes a housing or handle to support the blade in the open position and for receiving the blade in the closed position. Challenges lie in starting the movement of a knife blade. Controlling movement of a pivoting knife blade is generally known and examples of such control can be found in Collins U.S. Pat. No. 5,815,927, Glesser U.S. Pat. No. 6,918,184, Leatherman's flipper knife models E306x and E307x, Onion U.S. Pat. Nos. 6,591,504, and 6,145,202, and Onion U.S. Patent Application Publication 2005/0132576.

The actuator and stop mechanism of the present invention overcomes the various deficiencies of folding knives and opening and closing mechanisms presently known in the knife and cutlery industry by providing positive opening and closing assistance while enabling such opening and closing to be performed with only a single hand of the user.

### BRIEF SUMMARY

This invention generally provides for a folding knife mechanism comprising a blade, a handle for receiving and supporting the blade and a lever operated blade actuator that provides positive assistance for opening the blade.

According to one embodiment, the mechanism includes an actuator pivotally attached to an interior of a knife handle and linked to a blade's tang by a blade pin or other projecting member that projects from the blade's tang and extends through a primary groove formed in the interior of the knife handle and an actuator groove formed in the actuator.

According to one embodiment, force, typically from the user, is applied to an actuator via a digit tab to initiate an arcuate movement of the blade actuator, causing a blade pin coupled within an actuator groove to move along a primary groove formed in a knife handle, thereby causing the knife blade to pivot about its pivot point.

### BRIEF DESCRIPTION OF THE SEVERAL VIEWS OF THE DRAWINGS

FIG. 1 depicts a profile view of the present invention with the blade in an open position.

FIG. 2 depicts a profile view of the present invention showing a blade in a closed position.

FIG. 3 depicts a profile cutaway view of an embodiment of the present invention with the blade in a closed position.

FIG. 4 depicts a profile cutaway view of an embodiment of the present invention with the blade in a partially open/closed position.

FIG. 5 depicts a profile cutaway view of an embodiment of the present invention with the blade in a closed position

FIG. 6 depicts a cutaway profile view of another embodiment of the present invention with a blade in a closed position.

FIG. 7 depicts a cutaway profile view of yet another embodiment of the present invention with a blade in an open position.

### DETAILED DESCRIPTION

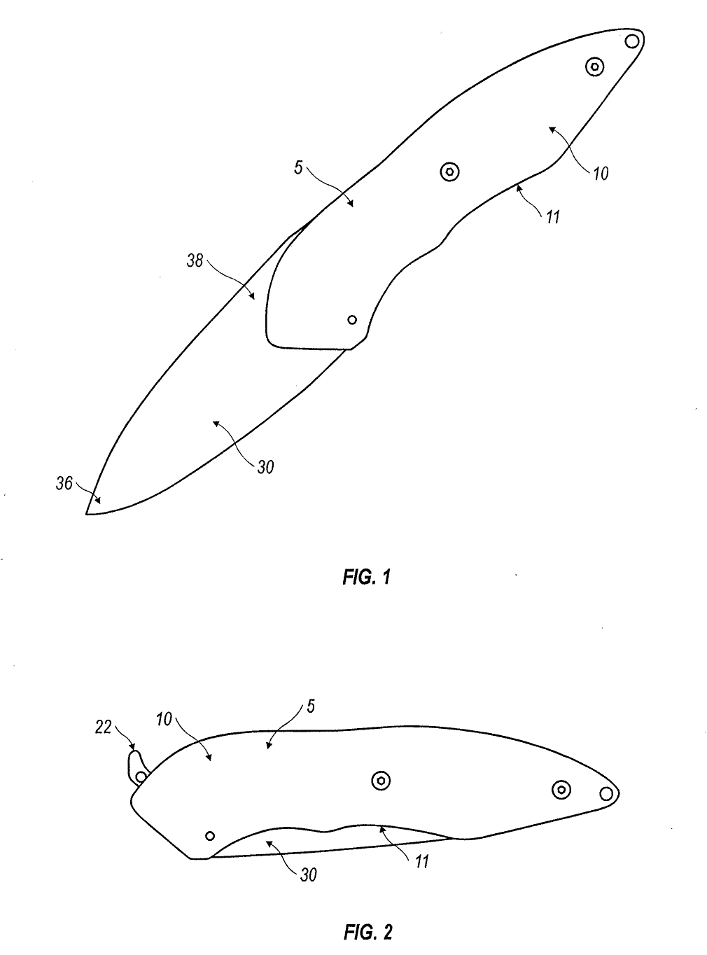

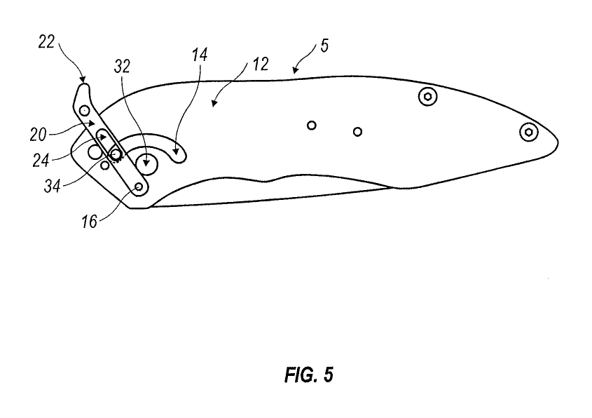

According to a first embodiment, as shown in FIGS. 1-5, a folding knife 5 includes a handle 10 with a liner 12. A central cavity 11 is formed in handle 10 to receive blade 30. The interior of the central cavity 11 is shaped according to the form of the blade 30 and forms a housing for the blade 30 when the blade is placed in the closed position.

The blade 30 has a distal end 36 and a proximal end 38, with tang 35 located at the proximal end 38. The tang 35 is pivotally connected to handle 10 by a blade pivot 32.

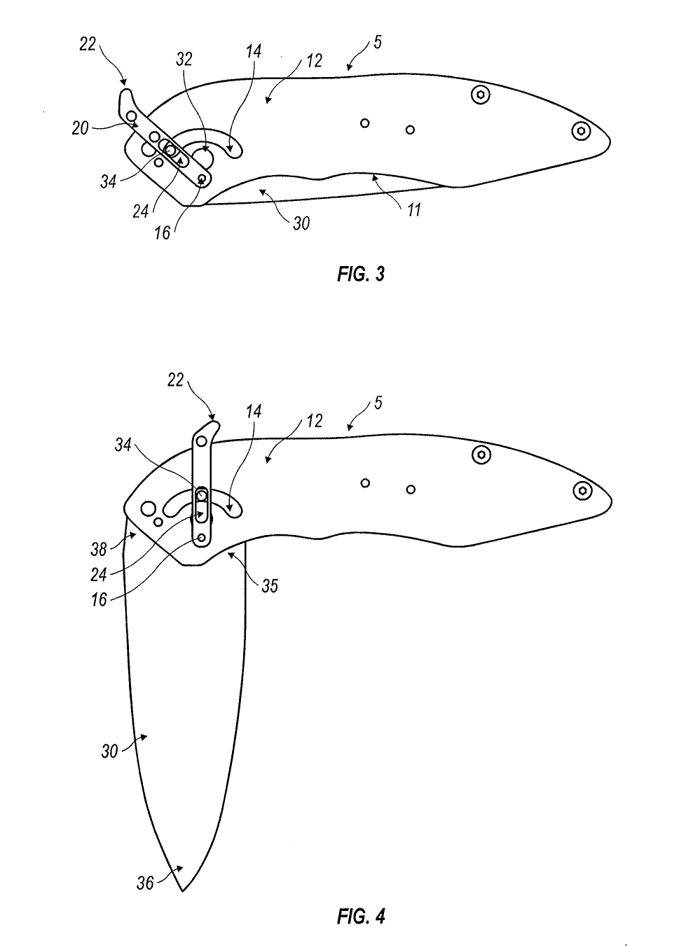

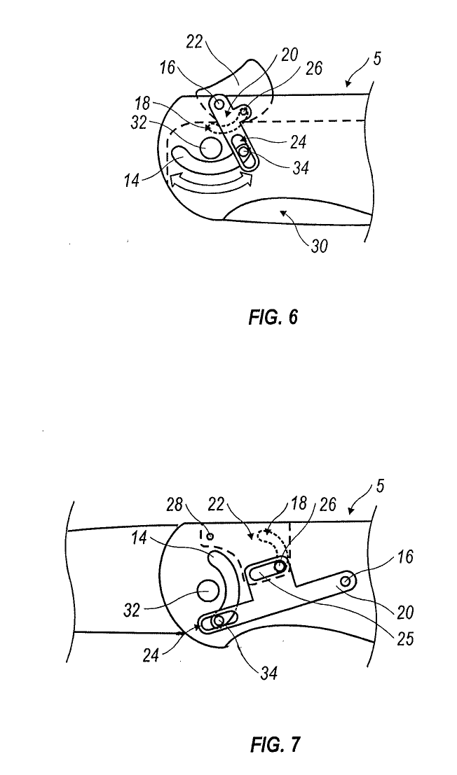

A primary groove 14 with an arcuate shape is formed in liner 12 and at least partially surrounds blade pivot 32. In the embodiment shown in FIGS. 1 through 5 and the embodiment of FIG. 6, the primary groove has an orientation in which the end regions of the primary groove are generally in line with a longitudinal axis of handle 10. In the embodiment shown in FIG. 6, the mid-section of primary groove 114 is distal to digit tab 122, relative to the blade pivot 32, while in the embodiment shown in FIGS. 1 through 5, and as best seen in FIGS. 3 through 5, the mid-section of primary groove 14 is proximal to digit tab 22, with reference to pivot 32. In yet another embodiment, as shown in FIG. 7, the orientation of primary groove 214 is such that one end region of primary groove 214 is proximal to digit tab 222 and the other end region of primary groove 214 is distal to digit tab 222, again with reference to pivot 32.

An actuator 20 is pivotally attached to liner 12 on the side of the liner 12 opposite the blade by an actuator pivot 16, as depicted in FIGS. 3 through 5. A shallow recess 13 is formed in the handle 10 to accommodate the actuator 20 between the handle 10 and liner 12. The end region of actuator 20 that is distal to actuator pivot 16 is formed into a digit tab 22. Digit tab 22, as shown in FIGS. 2 through 5, extends above the back side of handle 10 when knife blade 30 is not in an open position. When knife blade 30 is in a fully open position, digit tab 22 is in a flush position with the back side of handle 10, as shown in FIG. 1. In embodiments where the digit tab is wider than the shallow recess, a tab recess can be formed in the handle to receive the digit tab while the blade is in the open position.

According to other embodiments of the invention, the digit tab is separate from the actuator, as described with reference to FIGS. 6 and 7, for example FIG. 6 illustrates an embodiment where both digit tab 122 and actuator 120 are pivotally connected to liner 112 by actuator pivot 116. In this embodiment, digit tab 122 is on one side of liner 112 and actuator 120 is on the other side of liner 112. Digit tab 122 connects to actuator 120 by an actuator pin 126, or other projecting member, which extends through a secondary groove 118 formed in liner 112.

Similar to the embodiment in FIG. 6, the embodiment depicted in FIG. 7 shows an arrangement where a digit tab 222 is on one side of liner 212 and actuator 220 is on the other side of liner 212 and connected to each other by an actuator pin 226 which is coupled to the digit tab 222 and extends through a secondary groove 218 formed in liner 212 and through a secondary actuator groove 225 formed in the actuator 220. However, in the embodiment shown in FIG. 7, digit tab 222 and actuator 220 move about separate pivots. Specifically, digit tab 222 pivots about a digit tab pivot 228 and actuator 220 pivots about an actuator pivot 216.

According to the embodiment shown in FIGS. 3 through 5, blade 30 pivots about blade pivot 32 as a result of blade pin 34 being moved about primary groove 14 by actuator 20 pivoting about actuator pivot 16. Movement of actuator 20 about actuator pivot 16 is accomplished by a user pressing against digit tab 22. Movement of digit tab 22 towards the handle end region distal to the blade pivot 32 results in moving blade 30 out of cavity 11 to an open position.

With reference to the embodiment shown in FIG. 6, a user's application of force to the digit tab 122 causes digit tab 122 on the inside of liner 112 and coupled to actuator 120 on the outside of liner 112 to pivot about actuator pivot 116. In turn, blade pin 34 moves about primary groove 14 by the pivot motion of actuator 120, thereby moving blade 30 about blade pivot 32. In such an arrangement, digit tab 122 can be used as a blade stop as described in Provisional Patent Application 60/687,004 filed Jun. 4, 2005 entitled Knife Blade Arrestor, incorporated herein by reference in its entirety.

As shown in FIG. 7, a user's application of force to the digit tab 222 causes digit tab 222 on the inside of liner 212 and actuator 220 on the outside of liner 212 to each pivot upon their respective pivot points, namely digit tab 222 pivoting upon digit tab pivot 228 and actuator 220 pivoting upon actuator pivot 216. In turn, blade pin 34 moves about primary groove 14 by the pivot motion of actuator 220 thereby moving blade 30 about blade pivot 32. In such an arrangement, digit tab 222 can be used as blade stop as described in Provisional Patent Application 60/687,004 filed Jun. 4, 2005 entitled Knife Blade Arrestor.

In the embodiments described above with reference to FIGS. 1-7, a blade pin or projecting member projects from the blade at the tang region through a primary groove. Additionally the blade pin further extends through an actuator groove formed in the actuator. The actuator groove is shown as being linear, with a longitudinal axis that, when extended, passes through the center of the actuator pivot 16. However, by changing the shape or orientation of the actuator groove, the operating characteristics of the mechanism can be further modified.

According to another embodiment, the actuator does not include a groove, but is instead positioned beside the blade pin so that, when pressure is applied to the digit tab by a user, the actuator pushes the blade pin and blade toward the open position. A light spring biases the actuator so that it remains in its recess while the blade is open.

In the embodiments of FIGS. 1-7, the actuator is shown and described as being positioned on a side of the liner opposite the blade. According to other embodiments, an actuator is coupled to a surface of the liner facing the blade, but in other respects operates substantially as described above. In still further embodiments, the knife handle is a solid frame type handle, i.e., no liner is employed, and an actuator is coupled to a surface of the handle facing the blade, to operate, again, substantially as described above.

It will be appreciated that a pivoting actuator operatively coupled to a blade pin or other projecting member allows a knife designer the freedom to design the movement or throw of a digit tab for a particular purpose without being limited to a blade's range or rate of motion about its pivot point, in contrast to conventional flipper folding knives in which the finger tab is fixed to the blade. It is contemplated that a pivoting actuator provides novel solutions to blade movement of folding knives.

All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

It will be understood that certain features and sub-combinations are of utility and may be employed without reference to other features and sub-combinations. This is contemplated by and is within the scope of the claims. Since many possible embodiments of the invention may be made without departing from the scope thereof, it is to be understood that all matter herein set forth or shown in the accompanying drawings is to be interpreted as illustrative and not in a limiting sense.

What is claimed is:

1. A knife, comprising:
a blade having a tang extending outwardly from said blade;
a handle having at least one liner and a blade cavity;
a primary groove formed in said liner;
said tang pivotally connected to said handle;
a projecting member extending from said tang and through said primary groove; and
an actuator pivotally connected to said liner by an actuator pivot, wherein said projecting member extends through an actuator groove formed in said actuator to form an operative linkage to move a blade between open and closed positions.

2. The knife of claim 1 wherein a digit tab is fixed to an end region of said actuator distal to said actuator pivot.

3. The knife of claim 1 wherein a digit tab is pivotally fixed to said liner by said actuator pivot, wherein said liner is disposed between said digit tab and said actuator and said digit tab and said actuator are coupled to each other by an actuator pin which extends through a secondary groove formed in said liner.

4. The knife of claim 1 wherein a digit tab is pivotally fixed to said liner by a digit tab pivot, wherein said liner is disposed between said digit tab and said actuator and said digit tab and said actuator are coupled to each other by an actuator pin which extends through a secondary groove formed in said liner.

5. The knife of claim 1 wherein said projecting member is a pin.

6. A folding knife, comprising:
a handle;
a blade coupled to the handle and pivotable around a pivot axis, with respect to the handle, between an open position and a closed position; and
an actuator coupled to the handle and pivotable around an actuator axis, with respect to the handle, between a first position and a second position, the actuator axis extending parallel to the pivot axis and spaced away therefrom, the actuator engaging a feature of the blade to pivot the blade toward the open position when the actuator is pivoted from the first position toward the second position.

7. The knife of claim 6 wherein the feature of the blade is a projecting member extending outward from a tang of the blade.

8. The knife of claim 7 wherein the actuator includes an actuator groove in which the projecting member is slidably received.

9. The knife of claim 7 wherein the projecting member is a pin coupled to the blade and extending therefrom.

10. The knife of claim 6 wherein the actuator is coupled at a first end to the handle, with a second end thereof extending to a position accessible to a user from outside the handle.

11. The knife of claim 10 wherein the second end of the actuator is in the form of a digit tab.

12. The knife of claim 10 wherein the second end of the actuator is accessible to a user from outside the handle while the blade is in the closed position, and the second end of the actuator is positioned in a recess formed in the handle while the blade is in the open position.

14. The knife of claim 6, further comprising a digit tab pivotably coupled to the handle and movable between an extended position, in which the digit tab extends from the handle, and a recessed position, in which the digit tab is substantially received in a recess formed in the handle.

15. The knife of claim 14 wherein the digit tab is coupled to the actuator such that movement of the digit tab from the extended position to the recessed position moves the actuator from the first position to the second position.

16. The knife of claim 15 wherein the handle comprises a liner, and wherein the digit tab is positioned on a side of the liner opposite the actuator.

17. The knife of claim 15 wherein the digit tab is pivotable, relative to the handle, around the actuator axis.

18. The knife of claim 15 wherein the digit tab is pivotable, relative to the handle, around a digit tab axis extending parallel to and spaced away from the pivot and actuator axes.

19. The knife of claim 18 wherein the digit tab is coupled to the actuator by an actuator pin.

20. The knife of claim 18 wherein the actuator comprises an actuator groove in which the actuator pin slides.

21. The knife of claim 6 wherein the handle comprises a liner, and wherein the actuator is positioned on a side of the liner opposite the blade.

22. The knife of claim 21 wherein the liner comprises an arcuate groove, and the feature of the blade is a projecting member extending from a tang of the blade through the arcuate groove to the side opposite the blade.

23. A knife, comprising:
a handle;
a blade pivot extending transversely through the handle;
a blade coupled to the handle by the blade pivot and configured to rotate around the blade pivot between a closed position, in which the blade is substantially received inside the handle, and an open position, in which the blade extends from the handle;
a blade pin extending outward from a tang of the blade; and
an actuator coupled at a first end to the handle by an actuator pivot and having an actuator groove in which the blade pin is slidably positioned, the actuator configured to move the blade toward the open position when a user applies force to a second end thereof.
